(19) United States
(12) Patent Application Publication
(10) Pub. No.: US 2011/0121948 A1
(43) Pub. Date: May 26, 2011

(54) Security Screening

(75) Inventors: Christopher Robert Lawrence, Farnborough (GB); David Thomas Steele, Hook (GB)

(73) Assignee: QINETIQ LIMIETD, London (UK)

(21) Appl. No.: 13/055,860

(22) PCT Filed: Jul. 29, 2009
(86) PCT No.: PCT/GB2009/001837

§ 371 Date: Jan. 25, 2011

(30) Foreign Application Priority Data
Aug. 1, 2008 (GB) 0814077.4

(51) Int. Cl. H04Q 5/22

(52) U.S. Cl. 340/10.1

(57) ABSTRACT

An RF screening apparatus comprising a scanning chamber and an RF inspection device or reader, the chamber having chamber walls which are substantially reflective to radiation at a frequency of operation. The chamber walls or at least a portion of the chamber walls may be visually transparent. This enables visual inspection and identification of the occupant and RF interrogation to be performed, substantially simultaneously if desired. RF interrogation signals produced by the reader reflect off the chamber walls, approaching a target tag from an increased number of different angles, thus increasing the chance of a successful read.

The present invention relates to security screening, and in particular to RF enabled security methods and apparatus.

One of the ways in which specific high-value assets can be monitored as they enter or leave a premises is by the use of radio-frequency identification (RFID) tags, enabling both security and asset-tracking capabilities. Such a tag will typically be either active (internally powered, sending out a signal of its own) or passive (relying upon external interrogation to power the tag and enable it to send back information to the interrogator), and will have a characteristic maximum read range associated with it. The maximum read ranges of active tags tend to be larger than those of passive tags.

Tag performance—often characterised by the maximum read range—tends to be influenced by environmental conditions. Quoted values are usually for ideal read condition in the absence of any factors which might adversely affect performance. Perhaps the most common factor which can be detrimental to tag performance is the physical environment surrounding the tag. Examples include material on which the tag is mounted (especially conductors) and physical barriers between the tag and the reader. In the example of tracking assets as they enter or leave a premises, examples include people between the scanner and the tag, or an arm that obscures the tag whilst carrying the asset. It is therefore common practice to mount the interrogating/receiving antenna in a doorway or corridor which acts as a choke-point, restricting the number of people in the antenna's ‘line of sight’ and assisting in bringing the tag and reader into close proximity.

However, the tag on an asset may still be obscured by the person carrying it, or the tag may be aligned in a way that limits the efficiency of the reader. Read reliability can be improved by using large number of antennas (increasing the number of angles from which the tag is interrogated), however this adds cost and complexity, increasing the possibility of interference between adjacent devices.

According to a first aspect of the invention there is provided an RF screening apparatus comprising a scanning chamber defined by chamber walls, said scanning chamber having at least one access portal; and an RF inspection device including an antenna for producing an interrogating field in said chamber at a first frequency; wherein said chamber walls are substantially reflective to radiation of said first frequency.

In preferred embodiments, the chamber may physically resemble cylindrical security portals employed at certain high security sites such as embassies or banks. In such cases the chamber walls completely enclose the scanning chamber, however in certain embodiments the walls may only partially enclose the chamber. The chamber may for example comprise two substantially parallel side walls, roof and floor sections, leaving two open sides for entry and exit.

The present invention offers improved RF interrogation performance. RF interrogation signals produced by the antenna(s) reflect off the chamber walls, approaching a target tag from an increased number of different angles, thus increasing the chance of a successful read. Similarly, the response from the tag (or the signal in the case of an active tag) is reflected back into the chamber, again increasing the likelihood of successful detection at the reader.

It will be understood that the frequency of operation will not be perfectly limited to a single frequency, but will be a band of frequencies centred about a nominal. It is convenient to refer to this centre value, and references to frequency values in this specification should be construed accordingly.

In embodiments, the chamber walls or at least a portion of the chamber walls are visually transparent, constructed of glass or plastic for example. This enables visual inspection and identification of the occupant and RF interrogation to be performed, substantially simultaneously if desired, and is less disconcerting to the user (less claustrophobic). Preferably at least 50% of the chamber walls are substantially transparent, more preferably at least 75%. In such embodiments, in order to maintain reflectivity at the frequency of operation, an appropriately sized wire mesh can be applied to or integrated into the transparent walls or transparent wall panels. Alternatively, an appropriate optically-transparent electrode material could be applied as an appliqué or direct coating to the walls of the chamber, examples including a half-silvered layer, indium tin oxide (ITO) or single-walled carbon nanotube (SWCNT) films of an appropriate thickness. The RF reflectivity of such materials can vary with parameters such as thickness, however reflectivities of 60% and over or 80% and over are desirable. Reflectivity should be provided over a suitable range of angles of incidence.

Outside of the frequency band of operation the reflectivity may fall away to substantially zero, and in fact in certain embodiments it may be arranged that the chamber walls are substantially transparent to radiation at a second predetermined frequency, different to said first frequency.

Another parameter which may vary between embodiments is the degree of visual transparency. Although optical transmission can be specified for any given wavelength, it is the combined transmission across the range of visible wavelengths to allow visual inspection of the chamber which is significant here. Even if a particular mesh or ITO coating reduces the optical transmission in some or all visible wavelengths to an extent, the result can still be said to be visually transparent. The term “visually transparent” is used in this specification to indicate that an image of the interior of the chamber can be obtained through the chamber walls which is sufficiently defined and representative to perform visual inspection e.g. inspection by a security guard of the behaviour of a human occupant.

In some embodiments, the chamber may be visually transparent for the purposes of inspecting the inside from the outside, but substantially opaque looking out. This may be achieved by illuminating the chamber from within, and using half-silvered chamber walls for example. In such embodiments the benefit of the chamber being less disconcerting to a user is reduced, however the advantage of simultaneous RF scanning and visual inspection is maintained.

Where transparency is not required in the walls, a metal or metallic surface can simply be employed.

The floor of the chamber is advantageously reflective to radiation of said first frequency, to further improve reflection within the chamber. A convenient location for the antenna is above the chamber, contained above the ceiling of the chamber, however an antenna or antennas could alternatively or additionally be mounted below the floor or adjacent to the walls.

The access portal in the walls allows a user to enter and exit the chamber, and in the case of a fully enclosed chamber may be effected by a hinged or sliding portion of the chamber wall. Where the chamber is not fully enclosed, access may be by a gap in the chamber wall. Advantageously, two access portals are provided, which allows ‘air lock’ type operation of the chamber.

The invention extends to methods, apparatus and/or use substantially as herein described with reference to the accompanying drawings.

Any feature in one aspect of the invention may be applied to other aspects of the invention, in any appropriate combination. In particular, method aspects may be applied to apparatus aspects, and vice versa.

Preferred features of the present invention will now be described, purely by way of example, with reference to the accompanying Figures in which

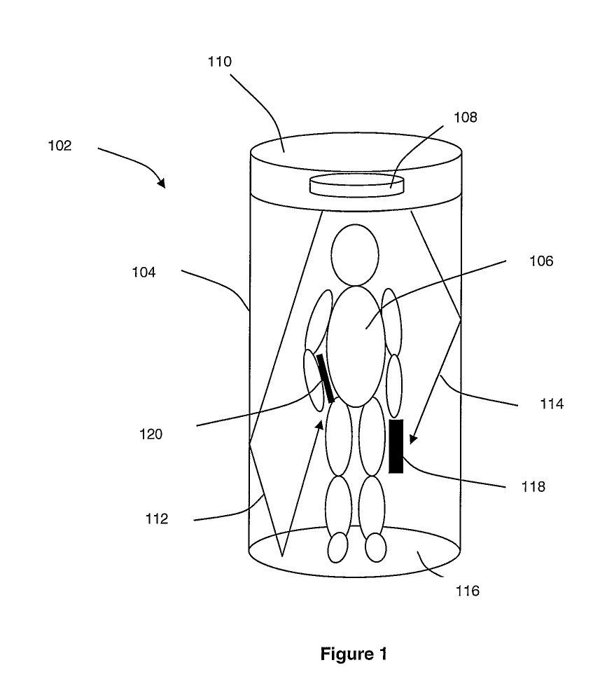

FIG. 1, illustrates schematically a screening system according to an aspect of the present invention.

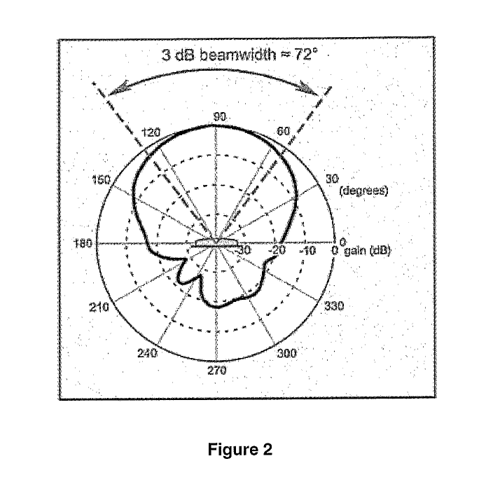

FIG. 2 shows a typical RFID antenna radiation intensity plot.

Screening system, generally designated 102, is in the form of an upright cylinder with curved side walls 104 defining a main chamber which is sufficiently large to accommodate a single standing occupant 106 to be scanned. Typically the chamber will have a diameter of approximately 1 m, and usually less than 2 m, and an internal height of approximately 2 to 3 m. An RFID reader device 108 is located in a compartment 110 located directly above the ceiling of the main chamber. In the present example the reader apparatus employs a monostatic antenna which both sends the interrogation signal and receives a possible response, however two antennas could be employed in a bistatic arrangement, with one sending and one receiving. Interrogating radiation at a selected frequency—in this example 866 MHz—propagates downwards from the reader 108, in order to detect the presence of an RFID tag or device on or about the occupant of the chamber.

Walls 104 and the floor 116 of the chamber are reflective to radiation at the selected frequency. As a consequence, radiation incident on the walls is reflected back into the chamber, arriving at the occupant at an angle which would not be possible from the reader alone. This is demonstrated in FIG. 1, with radiation 114 arriving at a briefcase 118 held by the occupant substantially from the side, and not from above. Reflection from the floor is illustrated by radiation 112 arriving at a portfolio 120 held by the occupant, substantially from below.

Modelling of the field intensity inside a glass walled cylinder with a standard UHF RFID antenna located at the top of the cylinder on the cylinder axis, shows a regular, standing wave pattern in which ‘null patches’ exist where the local field strength is very low, and a successful read of a tag is unlikely. Although the field does varies with time, modelling has identified that some static, low field positions exist, where read performance will be consistently poor.

Modelling of a similar cylinder having reflective walls shows a heavily distorted, irregular field. Again null patches do exist, but running the model over a period of time has shown that during a frequency cycle, no spatial position remains in a null field area.

In order to promote irregular field patterns inside the chamber it is desirable to increase the degree to which the radiation pattern emitted by the antenna interacts with the reflective chamber walls. FIG. 2 shows the field distribution (shown as antenna gain in dB) of a typical antenna, as might be employed in an embodiment of the invention. Radiation intensity in a plane orthogonal to the antenna's emitting surface is shown. It can be seen that a beam angle of 72 degrees defines the 3 dB (half power) beamwidth, giving an estimated solid beam angle of 1.6 steradians. It will be understood that in a cylindrical chamber having the approximate arrangement and dimensions described above, with such a beam pattern, a significant proportion of energy produced by the antenna will be incident on, and reflected off the chamber walls, thus promoting an irregular field pattern inside the chamber, in turn promoting high read rates at all positions inside the chamber. A 3 dB beam angle of 60 degrees or greater is therefore preferred. If necessary the reader antenna can be tilted and/or even rotated to promote a high degree of reflection within the chamber. Such an approach could be beneficial if the chamber geometry is necessarily awkward or reader power is restricted in some fashion. Both circularly or linearly polarised antennas could be employed.

In operation, a person using the screening system steps into the vertical cylinder when a doorway opens on one side (i.e. part of the cylinder's wall slides aside) and the door closes behind them. This guarantees that only one person enters at a time, and they may be scanned as they do so. Scanning for RFID tags and devices is performed, and visual and/or other electronic scanning may optionally be performed simultaneously. Visual inspection, either directly by an operator/guard, or remotely via a camera can readily detect suspicious behaviour e.g. deliberate attempts to screen or hide an object to avoid RFID detection. If the operator is content with the results of their scan, a doorway on the opposite side then opens to allow onward passage.

It will be understood that the present invention has been described above purely by way of example, and modification of detail can be made within the scope of the invention. The invention is equally applicable to detection of active and passive RFID tags, and may extend to other RF scanning technologies (e.g. mobile telephone detectors).

Each feature disclosed in the description, and (where appropriate) the claims and drawings may be provided independently or in any appropriate combination.

1. An RF screening apparatus comprising a scanning chamber defined by chamber walls, said scanning chamber having at least one access portal; and an RF inspection device including an antenna for producing an interrogating field in said chamber at a first frequency; wherein said chamber walls are substantially reflective to radiation of said first frequency.

2. Apparatus according to claim 1, wherein at least a portion of said reflective chamber walls are visually transparent.

3. Apparatus according to claim 2, wherein said walls include a conducting mesh.

4. Apparatus according to claim 2, wherein said walls include a layer of indium tin oxide (ITO).

5. Apparatus according to claim 1, further comprising a floor reflective to radiation of said first frequency.

6. Apparatus according to claim 1, wherein said antenna is housed above said scanning chamber.

7. Apparatus according to claim 1 wherein said antenna is angled relative to the chamber walls to promote reflection.

8. Apparatus according to claim 1 wherein the antenna is rotatable relative to the chamber.

9. Apparatus according to claim 1, wherein said chamber walls completely enclose said scanning chamber.

10. Apparatus according to claim 1 any preceding claim, further comprising a second access portal.

11. A method of screening comprising:
providing a scanning chamber defined by chamber walls which are substantially reflective to radiation of a first frequency,
producing an RF interrogating field in said chamber at said first frequency, and
detecting a response to said interrogating field.

12. A method according to claim 11, wherein said chamber walls are at least partially visually transparent, further comprising performing a visual inspection of the chamber through said chamber walls.
